(19) United States
(12) Patent Application Publication
(10) Pub. No.: US 2024/0266782 A1
(43) Pub. Date: Aug. 8, 2024

(54) CONNECTOR ASSEMBLY HAVING A SECONDARY LOCK SYSTEM (SLS) THAT PROVIDES AN ENGAGING AND WARNING SYSTEM, AND A METHOD FOR OPERATING THEREOF

(71) Applicant: J.S.T. CORPORATION, Farmington Hills, MI (US)

(72) Inventor: David DEMARATOS, Wixom, MI (US)

(73) Assignee: J.S.T. CORPORATION, Farmington Hills, MI (US)

(21) Appl. No.: 18/130,780

(22) Filed: Apr. 4, 2023

Related U.S. Application Data
(60) Provisional application No. 63/443,237, filed on Feb. 3, 2023.

(51) Int. Cl. H01R 13/641; H01R 13/627

(52) U.S. Cl. CPC H01R 13/641; H01R 13/627

(57) ABSTRACT

A secondary lock system connector assembly engaging and warning system, and a method for operating thereof includes a connector assembly having male and female connectors, the female connector having a secondary lock system (SLS) inside thereof. Engagement steps or assembling processes of the male and female connectors include Stage Nos. 1-4 depending on the position of the male connector inside the female connector. In Stage No. 1, the male connector begins to be brought towards the female connector such that a flag member of the SLS remains hidden inside the female connector. In Stage No. 2, the male connector enters the female connector and begins to engage with the SLS, while the flag member of the SLS continues to remain hidden inside the female connector. In Stage No. 3, an activating member of the male connector has engaged with the SLS, with the male and female connectors being partially mated, half-mated or at a pre-lock position, while the flag member of the SLS becomes elevated towards the outside of the female assembly in a visual and tactile warning position for an operator to see and observe. A spring element or component may be provided with the SLS for automatically or resiliently moving the flag member in or out of female connector to provide the engaging and warning system. In Stage No. 4, the male and female connectors become fully-mated or at a full-lock position, and the flag member of the SLS returns to its hidden position inside the female connector.

### CROSS-REFERENCE TO RELATED APPLICATION

This patent application claims priority to U.S. Provisional Patent Application No. 63/443,237 filed Feb. 3, 2023, which is hereby incorporated herein by reference in its entirety.

### BACKGROUND OF THE INVENTION

A connector assembly (such as that use in, for example, a vehicle high voltage connector assembly having a male connector and a female connector) often requires a combination of a primary lock system and a secondary lock system (SLS). This requirement for the connector assembly is independent from the use of a terminal position assurance (TPA) device and/or a connector position assurance (CPA) device. That is, the use of a TPA device, or a CPA device, or a TPA device and a CPA device with the secondary lock system is optional. With such a connector assembly, it is necessary for an operator of the connector assembly to be assured that the secondary lock system has been fully-mated or in a full-lock position to ensure that the male and female connectors remain fully mater and at a full-lock position during assembly, transport, use, or the like thereof. In conventional connector assemblies, no such assurance is provided to the operator that the male and female connectors of the conventional connector assembly have fully-mated or afre in a full-lock position. That is, the operator of the conventional connector assembly is not provided with, for example, a visible indicator that, with the operation of the secondary lock system employed therein, the male and female connector have fully-mated or are in a full-lock position, thereby leaving only the primary lock system being engaged or locked. With such an occurrence with only the primary lock system being engaged or locked, the engaging portions (e.g., male connector and female connectors) may be disengaged or dislodged resulting in separation during assembly, transport, use, or the like of the connector assembly)

It is thus necessary to provide a visible engaging and warning system for the operator so as to provide the needed assurance to the operator, with the employment of a secondary lock system, that the male and female connectors are fully-mated or in a full-lock position, and a method for operating thereof as in this invention. The secondary lock system for the connector assembly that provides the engaging and warning system, and a method for operating thereof in this invention do not require any extra step from the operator to operate the connector assembly, and eliminates any possibility that the operator may forget to fully engage the secondary lock system of the connector assembly of this invention for ensuring that the male and female connectors of the connector assembly are fully mated or at a full-lock position.

### SUMMARY OF THE INVENTION

The connector assembly that has a secondary lock system (SLS), which provides the engaging and warning system, and the method for operating thereof include the connector assembly having the male and female connectors, the female connector having the secondary lock system (SLS) of this invention located inside the female connector. The secondary lock system of this invention and its use or operation are independent from the use of a terminal position assurance (TPA) device and/or a connector position assurance (CPA) device. That is, the use of a TPA device, or a CPA device, or a TPA device and a CPA device with the secondary lock system of this invention is optional. Further, the secondary lock system of this invention is, generally, used with a conventional primary lock system and/or the CPA and/or TPA.

When the secondary lock system of this invention is provided or in use with a conventional primary lock system and/or a conventional CPA and/or TPA, the engagement steps of the male and female connectors of the connector assembly are described herein as Stage No. 1, Stage No. 2, Stage No. 3, and Stage No. 4. The connector assembly in Stage No. 1 has the male connector beginning to be brought towards the female connector such that a flag member of the secondary lock system of this invention within the female connector remains hidden. The connector assembly in Stage No. 2 has the male connector inside the female connector and begins to engage with the secondary lock system of this invention, while the flag member of the secondary lock system within the female connector continues to remain hidden. The connector assembly in Stage No. 3 has the male connector inside the female connector and an activating member of the male connector begins to engage with the bottom portion of the secondary lock system of this invention, with the male and female assemblies being partially mated, half-mated or at a pre-lock position, while the flag member of the secondary lock system becomes elevated outside of the female assembly in a visual and tactile warning position seen or observed by the operator. The connector assembly in Stage No. 4 has the male connector inside the female connector with the male and female assemblies being fully-mated or at a full-lock position, while the flag member of the secondary lock system has returned to its hidden position inside the female connector.

The secondary lock system of this invention contained inside the female connector provides an operator, having seen or observed the flag member of the secondary lock system becoming elevated outside of the female assembly in Stage No. 3, with a visual and tactile warning that the male connector is partially mated, half-mated or in a pre-lock position with the female connector (i.e., an indication to the operator that the male and female connectors are not yet fully mated or not yet a full-lock position). Thereafter, when the flag member of the secondary lock system returns to its hidden position inside the female connector, the user is further provided with another visual and tactile warning that the the male connector is fully-mated or in a full-lock position with the female connector, thereby providing assurance to the operator that the male and female connectors of the connector assembly, during assembly, transport, use, or the like will remain fully engaged or connected.

### BRIEF DESCRIPTION OF THE DRAWINGS

FIG. 1 is a side elevational view of a connector assembly in Stage No. 1 showing a male connector beginning to be brought towards a female connector such that a flag member of the secondary lock system (SLS) of this invention, within the female connector, remains hidden.

FIG. 2A is a top perspective view of the connector assembly in Stage No. 1 showing the male connector beginning to be brought towards the female connector such that the flag member of the secondary lock system of this invention, within the female connector, remains hidden; and FIG. 2B is an enlarged view of the flag member of the secondary lock system of this invention showing the flag member remaining hidden inside the female connector.

FIG. 3 is a side elevational view of the connector assembly in Stage No. 2 showing the male connector inside the female connector and beginning to engage with the secondary lock system of this invention, while the flag member of the secondary lock system, within the female connector, remains hidden.

FIG. 4a is a top perspective view of the connector assembly in Stage No. 2 showing the male connector inside the female connector and beginning to engage with the secondary lock system of this invention; and FIG. 4B is an enlarged view of the flag member of the secondary lock system of this invention showing the flag member remaining hidden inside the female connector.

FIG. 5 is a side elevational view of the connector assembly in Stage No. 3 showing the male connector inside the female connector, the male connector now being engaged with the secondary lock system of this invention, with the male and female connectors being partially mated, half-mated or at a pre-lock position, while the flag member of the secondary lock system has been elevated outside of the female assembly in a visual and tactile warning position to be seen or observed by an operator.

FIG. 6A is a top perspective view of the connector assembly in Stage No. 3 showing the male connector inside the female connector, the male connector being engaged with the secondary lock system of this invention, with the male and female connectors being partially mated, half-mated or at a pre-lock position; and FIG. 6B is an enlarged view of the flag member of the secondary lock system showing the flag member being elevated outside of the female assembly in the visual and tactile warning position to be seen or observed by the operator.

FIG. 7 is a side elevational view of the connector assembly in Stage No. 4 showing the male connector inside the female connector with the male and female connectors being fully-mated or at a full-lock position, while flag member of the secondary lock system has returned to its hidden position inside the female connector.

FIG. 8A is a top perspective view of the connector assembly in Stage No. 4 showing the male connector inside the female connector with the male and female connectors being fully-mated or at a full-lock position; and FIG. 8B is an enlarged view of the flag member of the secondary lock system showing the flag member having returned to its hidden position inside the female connector.

FIG. 9 is a perspective view of the secondary lock system having the flag member showing the right outer side of the secondary lock system having ribs or ridges thereon, the right outer side of the secondary lock system being shown along with an arrow towards which the male connector enters the female connector of the connector assembly.

FIG. 10 is a perspective view of the secondary lock system having the flag member showing the left inner side of the secondary lock system having a partially angled bottom portion, the left inner side of the secondary lock system being shown along with an arrow towards which the male connector enters the female connector of the connector assembly.

FIG. 11 is a perspective view of the connector assembly in Stage No. 2 showing the male connector inside the female connector and beginning to engage with the secondary lock system of this invention, while the flag member of the secondary lock system of this invention within the female connector remains hidden.

FIG. 12 is a cross-sectional view, taken along cross-sectional line 12-12 illustrated in FIG. 11, of the connector assembly in Stage No. 2 showing the male connector inside the female connector, and further showing the male connector beginning to engage with the secondary lock system of this invention, while the flag member of the secondary lock system of this invention within the female connector remains hidden.

FIG. 13 is a perspective view of the connector assembly in Stage No. 3 showing the male connector inside the female connector, and further showing the male connector being engaged with the secondary lock system of this invention, with the male and female connectors being partially mated, half-mated or at a pre-lock position, while the flag member of the secondary lock system has been elevated outside of the female assembly in the visual and tactile warning position to be seen or observed by the operator.

FIG. 14 is a cross-sectional view, taken along cross-sectional line 14-14 illustrated in FIG. 13, of the connector assembly in Stage No. 3 showing the male connector inside the female connector, and further showing an activating member of the male connector being engaged with the bottom portion of the secondary lock system of this invention, with the male and female connectors being partially mated, half-mated or at a pre-lock position, while the flag member of the secondary lock system of this invention has been elevated outside of the female assembly in the visual and tactile warning position to be seen or observed by the operator.

FIG. 15 is a perspective view of the connector assembly in Stage No. 4 showing the male connector inside the female connector with the male and female connectors being fully-mated or at a full-lock position, while the flag member of the secondary lock system of this invention has returned to its hidden position inside the female connector.

FIG. 16 is a cross-sectional view, taken along cross-sectional line 16-16 illustrated in FIG. 15, of the connector assembly in Stage No. 4 showing the male connector inside the female connector with the male and female connectors being fully-mated or at a full-lock position, while the flag member of the secondary lock system of this invention has returned to its hidden position inside the female connector.

### DETAILED DESCRIPTION OF THE PREFERRED EMBODIMENTS

A connector assembly, generally referred to as reference number 1, which includes therein a secondary lock system 8 of this invention, is used with a conventional primary lock system and/or a conventional CPA (and/or TPA). Based on the standard practice in the art, the secondary lock system 8 of this invention presupposes the use of a primary lock system (in this case, a conventional primary lock system) with or without the use of a conventional CPA and/or TPA. Further, the secondary lock system 8 of this invention and its use or operation are independent from its use with the conventional primary lock system, and further independent from its use with the conventional CPA and/or TPA. Thus, only the secondary lock system 8 of this invention is described herein in detail.

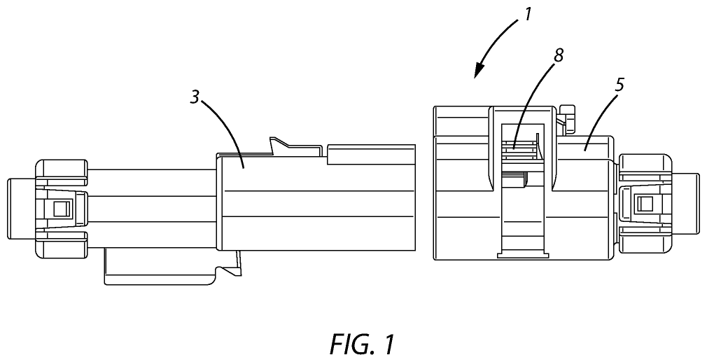

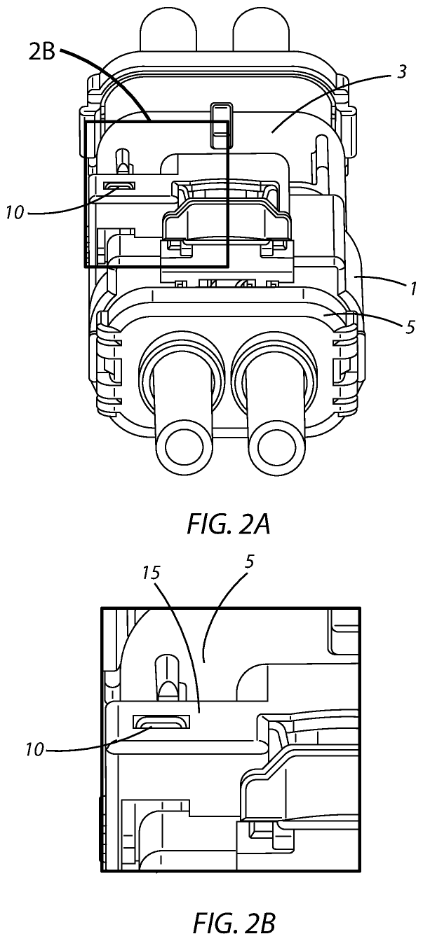

With a secondary lock system (SLS) 8 of this invention, the engagement steps or the assembling process of the male connector 3 and the female connector 5 of the connector assembly, are described herein as Stage No. 1, Stage No. 2, Stage No. 3, and Stage No. 4. FIG. 1 illustrates the connector assembly 1 in Stage No. 1 showing the male connector 3 beginning to be brought towards the female connector 5 such that the secondary lock system 8 of this invention within the female connector 5 remains hidden. The top perspective view, in FIG. 2A, of the connector assembly 1 in Stage No. 1 similarly shows the male connector 3 beginning to be brought towards the female connector 5 such that the secondary lock system 8 of this invention, having a flag member 10, within the female connector 5 remains hidden. An enlarged view, in FIG. 2B, of the flag member 10 of the secondary lock system 8 of this invention shows the flag member 10 staying hidden inside the female connector at Stage No. 1.

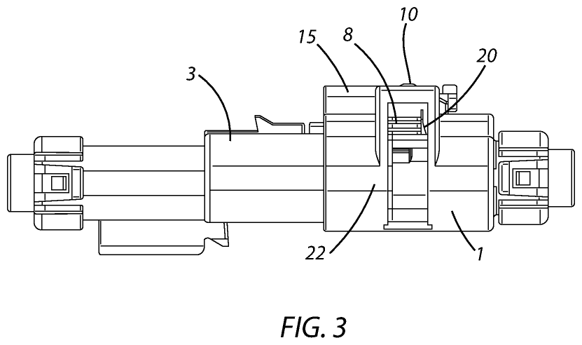

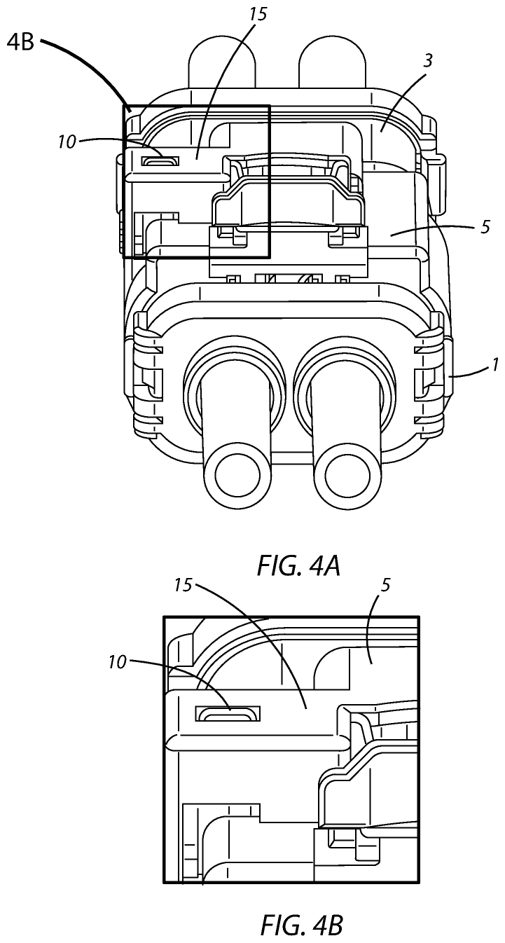

The engagement step of the connector assembly 1 in Stage No. 2, illustrated in FIG. 3, shows the male connector 3 inside the female connector 5, and the male connector 3 begins to engage (or engages) with the secondary lock system 8 of this invention. The term “engages” used here does not mean that the male connector 3 mates or locks with the female connector 5. Depending on how far the male connector 3 is slid into or pushed towards the female connector 5, the male connector 3 does not yet mate or lock with the female connector 5 in Stage No. 2. Also, the raising or upward movement of the flag member 10 of the secondary lock system 8 towards the outside of the female connector 3 (as seen in FIGS. 3, 4A, and 4B) depends on how far the male connector 3 is slid into or pushed towards the female connector 5. That is, the farther the male connector 3 is slid into or pushed towards the female connector 5, the higher the flag member 10 of the secondary female connector 5 extends past the upper surface 15 of the female connector 5.

A window 20 passing through a side 22 of the female connector 5 is also illustrated in FIG. 3. Through this window 20, the operation (i.e., the movement upward or downward) of the secondary lock system 8 can be seen or observed. The additional use of this window 20, passing through the female connector 5 will further be explained later when the operator desires to remove the male and female connectors 3, 5 from their fully-engaged or full-lock position.

FIG. 4a further illustrates the connector assembly 1 in Stage No. 2 showing the male connector 3 inside the female connector 5 and beginning to engage, but not mate or lock, with the secondary lock system 8 of this invention, while FIG. 4B shows the enlarged view of the flag member 10 of the secondary lock system 8 showing, for the most part, the flag member 10 remaining hidden inside the female connector 5. As discussed above, depending on how far the male connector 3 is slid into or pushed towards the female connector 5, the male connector 3 does not yet mate or lock with the female connector 5 in Stage No. 2. Also, the raising or upward movement of the flag member 10 of the secondary lock system 8 towards the outside of the female connector 3, as can be seen in FIGS. 4A, and 4B, depends on how far the male connector 3 is slid into or pushed towards the female connector 5. That is, the farther the male connector 3 is slid into or pushed towards the female connector 5, the higher the flag member 10 of the secondary female connector 5 extends past the upper surface 15 of the female connector 5.

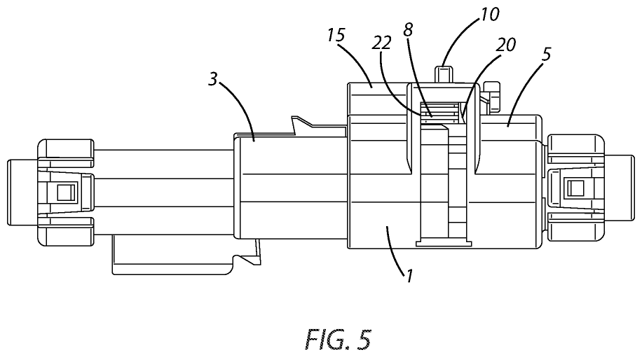

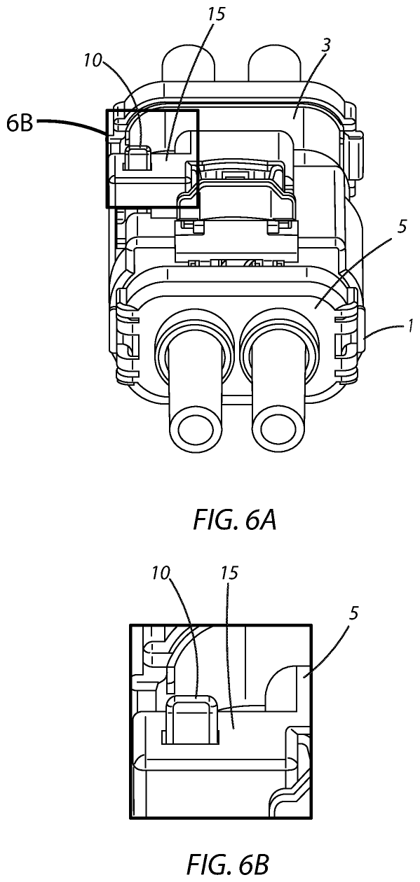

In the engagement step of the connector assembly 1 in Stage No. 3, illustrated in FIG. 5, the male connector 3 is partially slid into or pushed towards the inside the female connector 5 and engages with the secondary lock system 8 of this invention. As discussed above, the term “engages” used here does not mean that the male connector 3 mates or locks with the female connector 5. Depending on how far the male connector 3 is slid into or pushed towards the female connector 5, the male connector 3 partially engages or is at a pre-lock position with the female connector 5 in Stage No. 3. That is, in Stage No. 3, the male and female connectors 3, 5 become partially mated, half-mated or at a pre-lock position. In the engagement step of the connector assembly 1 at Stage No. 3, the flag member 10 becomes elevated pass the upper surface 15 of the female connector 5 and can be readily seen or observed outside the female assembly 5 by the operator, the flag member 10 of the secondary lock system 8 of this invention being at a visual and tactile warning position for the operator. In other words, the elevated flag member 10, as shown in FIGS. 5, 6A, and 6B, provides the essential visual and tactile warning to the operator that the male connector 3 has begun its engagement with the female connector 5; and that the male connector 3 partially inside the female connector 5 is engaged with the secondary lock system 8 of this invention, while the male and female assemblies 3, 5 are partially mated, half-mated or at a pre-lock position.

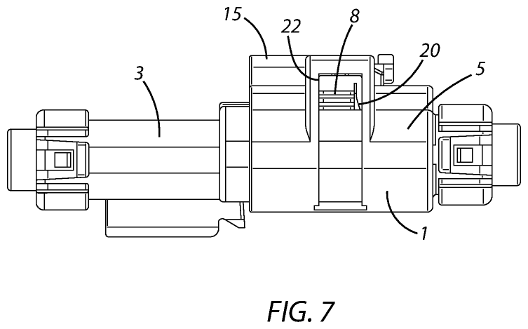

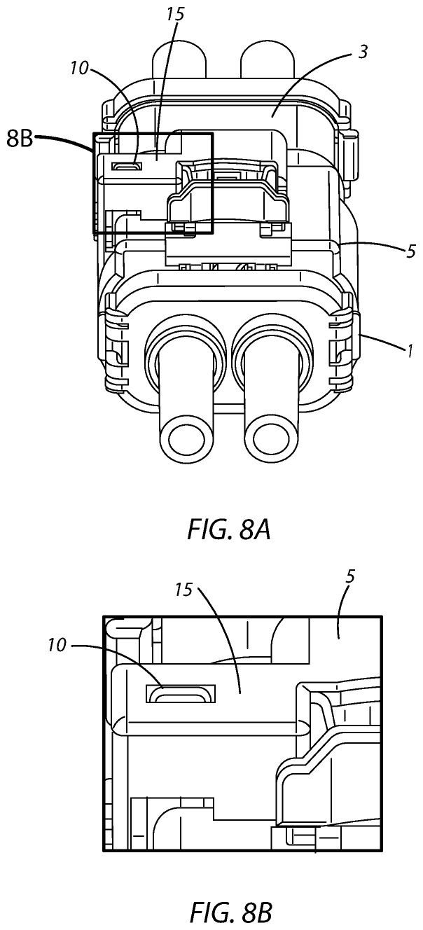

In the engagement step of the connector assembly 1 in Stage No. 4, as shown in FIG. 7, the male connector 3 enters the female connector 5, such that the male and female connectors 3, 5 become fully-mated or at a full-lock position, while the flag member 10 of the secondary lock system 8 of this invention has returned to its hidden position inside the female connector 5. As similarly illustrated in the top perspective view of the connector assembly 1 in FIG. 8A, the connector assembly 1 has the male and female connectors 3, 5 fully-mated or at a full-lock position; and in FIGS. 7, 8A, and 8B, it is shown that the flag member 10 of the secondary lock system 8 of this invention has returned to its hidden position inside the female connector 5.

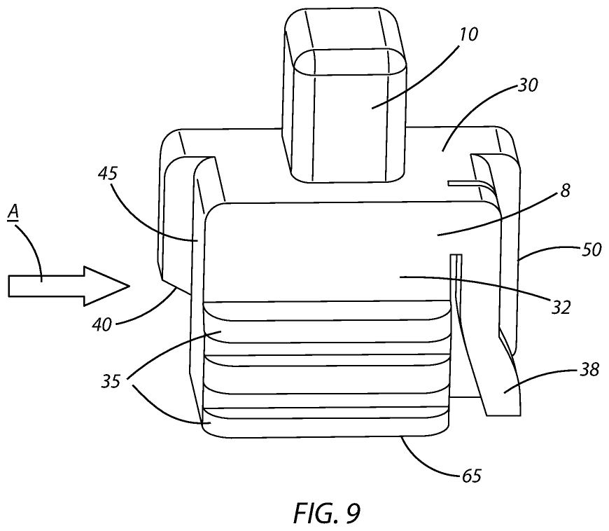

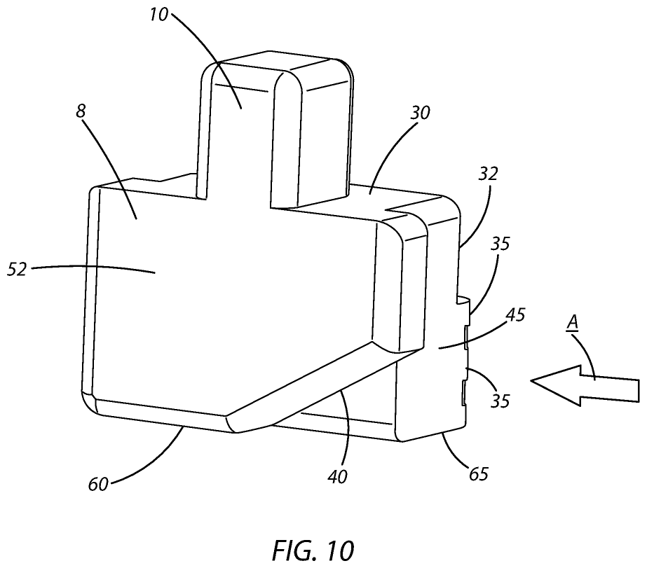

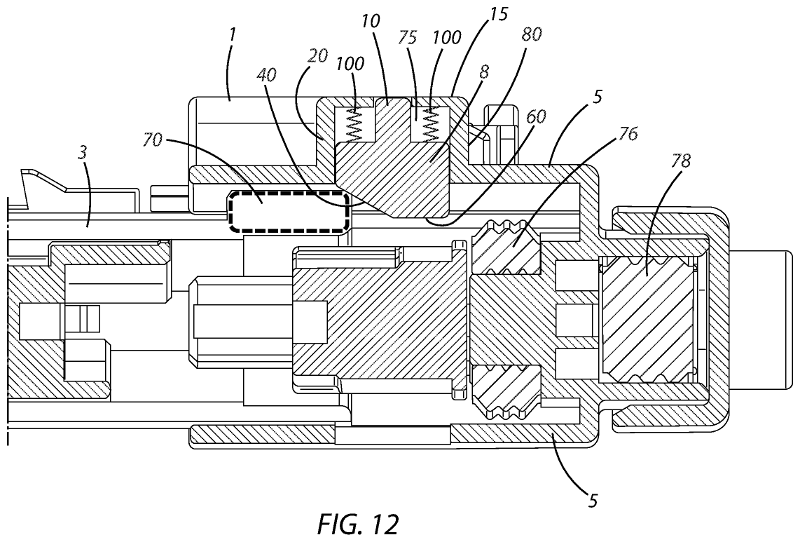

The secondary lock system 8 is illustrated, in more detail, in FIG. 9. The secondary lock system 8 includes the flag member 10 extending from a top surface 30 of the secondary lock system 8. Further shown in FIG. 9 is the right outer side 32 of the secondary lock system 8 having ribs or ridges 35 formed thereon. An arrow A is shown to illustrate the direction along which the male connector 3 enters the female connector 5 in the connector assembly 1 when the secondary lock system 8 is installed inside the female connector 5 of the connector assembly 1. FIG. 9 further shows a tang or lever-like member 38 to provide a feel of resiliency for the secondary lock system 8 when operating or traveling, up or down, inside the cavity 75 of the upper portion 80 of the female connector 5 (see, FIGS. 12, 14, and 16) through the upper surface 15 of the female connector 5. Also, partially shown in FIG. 9 is a partially angled bottom portion 40 of the secondary lock system 8, the angled bottom portion 40 of the secondary lock system 8 being more clearly shown in FIG. 10, and more fully discussed later.

FIG. 10 illustrates the secondary lock system 8 having the flag member 10, and further illustrates the left inner side 52 of the secondary lock system 8. FIG. 10 further shows the partially angled bottom portion 40 of the secondary lock system 8. The specific function of the partially angled bottom portion 40 of the secondary lock system will be discussed more fully below with respect to the cross-sectional views shown in FIGS. 12, 14, and 16. The partially angled bottom portion 40 extends downwards towards a partially flat bottom portion 60 of the secondary lock system 8. Further shown in FIG. 10 is another bottom portion 65 that extends apart from the partially angled bottom portion 40 and the partially flat bottom portion 60 of the secondary lock system 8.

Further illustrated in FIG. 10 is the arrow A, which illustrates the direction along which the male connector 3 enters the female connector 5 in the connector assembly 1 when the secondary lock system 8 is installed inside the female connector 5 of the connector assembly 1. As can be further seen in FIG. 10, the partially angled bottom portion 40 and the partially flat bottom portion 60 abut or join the left inner side 52 of the secondary lock system 8, while the another bottom portion 65 abuts or join the right outer side 32 of the secondary lock system 8 from which the ribs or ridges 35 are formed or extend, as discussed above with respect to FIG. 9.

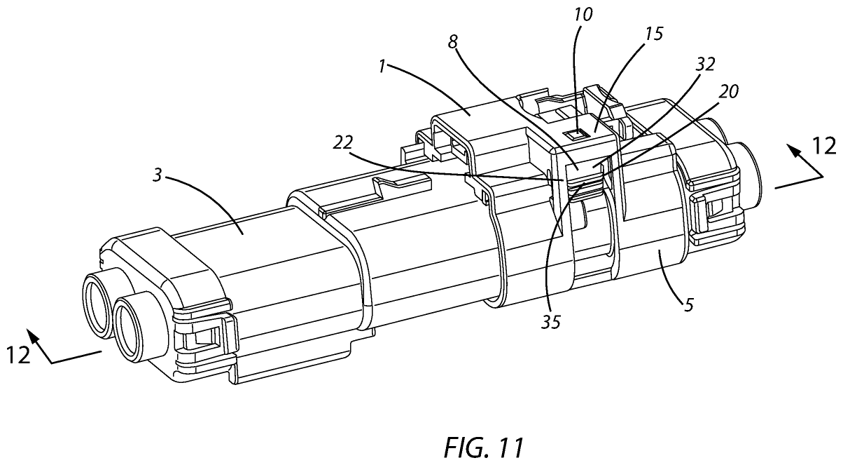

FIG. 11 is a perspective view of the connector assembly 1 in Stage No. 2 showing the male connector 3 partially inside the female connector 5, the male connector 3 beginning to engage with the secondary lock system 8 of this invention, while the secondary lock system 8 has the flag member 10 within the female connector 5, which remains hidden inside the female connector 5. The engagement step of the connector assembly 1 in Stage No. 2, illustrated in FIG. 11, shows the male connector 3 partially inside the female connector 5; and the male connector 3 begins to engage (or engages) with the secondary lock system 8. The term “engages” used here does not mean that the male connector 3 mates or locks with the female connector 5. As more fully explained with respect to FIG. 12, depending on how far the male connector 3 is slid into or pushed towards the female connector 5, the male connector 3 does not yet mate or lock with the female connector 5 in Stage No. 2. Also, the raising or upward movement of the flag member 10 of the secondary lock system 8 towards the outside of the female connector 3, as more clearly explained later with respect to FIG. 12, depends on how far the male connector 3 is slid into or pushed towards the female connector 5. In other words, the farther the male connector 3 is slid into or pushed towards the female connector 5, the higher the flag member 10 of the secondary female connector 5 extends past the upper surface 15 of the female connector 5. The upward or downward movement of the secondary lock system 8 can be seen or observed through the window 30 passing through the right outer side 32 of the secondary lock system 8.

FIG. 12 is a cross-sectional view, taken along cross-sectional line 12-12 illustrated in FIG. 11, of the connector assembly 1 in Stage No. 2, Here, it is shown that the male connector 3 has entered the female connector 5 and has begun to engage with the secondary lock system 8 of this invention, while the flag member 10 of the secondary lock system 8 remains hidden, in Stage No. 2, within a cavity 75 of an upper portion 80 of the female connector 5.

FIG. 12 further illustrates the connector assembly 1 in Stage No. 2 showing the male connector 3 inside the female connector 5 and beginning to engage, but not mate or lock, with the secondary lock system 8 of the female connector 5, while the flag member 10 remains hidden inside the female connector 5. Depending on how far the male connector 3 is slid into or pushed towards the female connector 5, the male connector 3 merely engages with the secondary lock system 8, but does not yet mate or lock with the secondary lock system 8 of the female connector 5 in Stage No. 2. Also, the raising or upward movement of the flag member 10 of the secondary lock system 8 towards the outside of the female connector 3 through the upper surface 15 of the female connector 3, as can be seen in FIG. 12, depends on how far the male connector 3 is slid into or pushed towards the female connector 5. That is, the farther the male connector 3 is slid into or pushed towards the female connector 5, the higher the flag member 10 of the secondary female connector 5 extends past the upper surface 15 of the female connector 5.

As more particularly illustrated in FIG. 12, the male connector 3 includes an activating member 70 that engages the partially angled bottom portion 40 of the secondary lock system 8. That is, as the female connector 3 is further slid into or pushed towards the female connector 5, the more the activating member 70 of the male connector 3 slides along the partially angled bottom portion 40 of the secondary lock system 8. As the activating member 70 of the male connector 3 slides along the partially angled bottom portion 40 of the secondary lock system, the secondary lock system 8 lifts up or is raised up towards the upper surface 15 of the female connector 5; and as the secondary lock system 8 lifts up or is raised up, the more the flag member 10 of the secondary lock system 8 is similarly lifted up or raised up pass the upper surface 15 of the female connector 5.

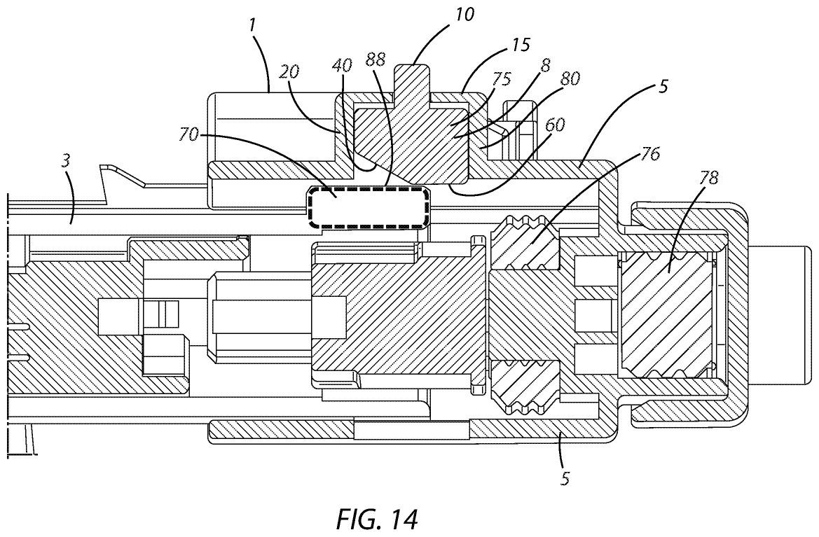

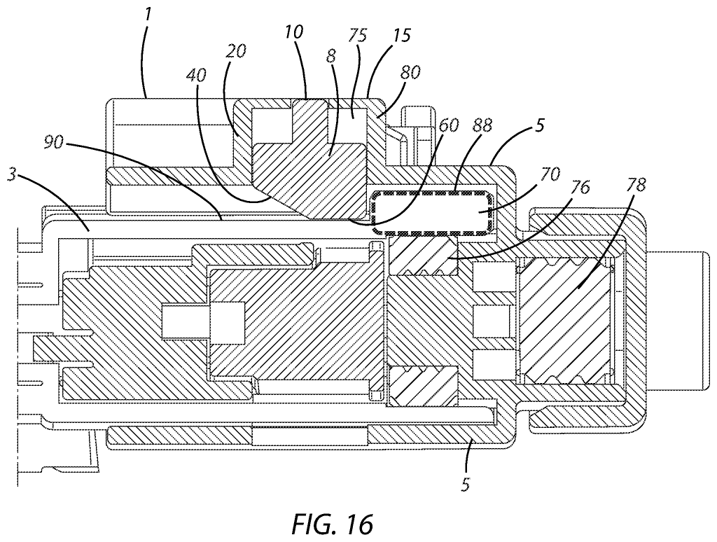

It is to be noted herein that the activating member 70 of the male connector 3 is illustrated in dashed lines to indicate that the shape thereof is not limited to a rectangle, as shown in FIG. 12 (and FIGS. 14 and 16). In other words, the activating member 70 may take any shape or form provided the activating member 70 is able to activate the secondary lock system 8 of this invention, in the manner discussed herein in the engagement steps or assembling process of the connector assembly, as further labeled herein as Stage Nos. 1 through 4.

Similarly illustrated in FIG. 12 is the cavity 75 within the upper portion 80 of the female connector 5 for accommodating therein the secondary lock system 8 and its corresponding flag member 10. Also shown in FIG. 12 are a number of seals 76, 78 within the female connector 5.

Further illustrated in FIG. 12 is at least a spring element or component 100 (i.e., one or more spring elements or components 100) within the cavity 75 near or adjacent the flag member 10 of the secondary lock system 8. The spring element or component 100 maybe one or more coil springs near or adjacent the flag member 10 of the secondary lock system 8 or a coil spring that substantially surrounds the flag member of the secondary lock system 8 within the cavity 75. Alternatively, the spring element or component 100 may be a disk spring, a leaf spring, a gas spring, or the like, or any component that stores and releases energy. The spring element or component 100 is, for example, used to “automate” the function of the secondary lock system 8, so that the operator does not have to lock the secondary lock system 8 manually. With such a structural element, the operator does not need to manipulate or assist the secondary lock system 8 in moving up or down in the female connector 5.

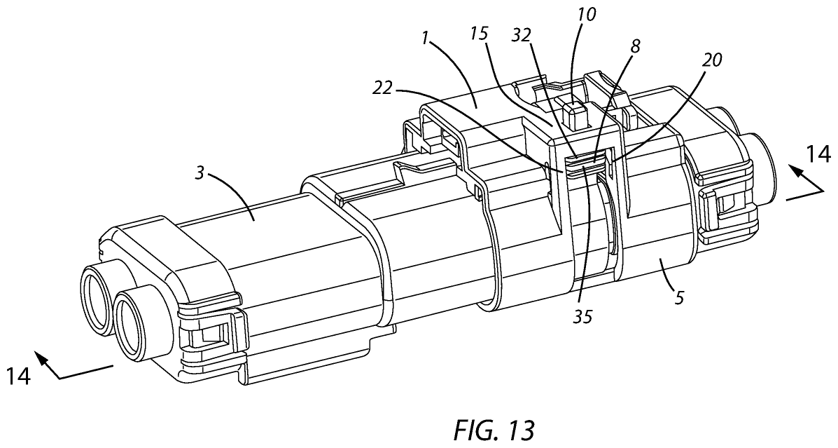

FIG. 13 shows the connector assembly 1 in Stage No. 3 with the male connector 3 partially inside the female connector 5 and has engaged with the secondary lock system 8 of this invention, while the male and female connectors 3, 5 become partially mated, half-mated or at a pre-lock position (i.e., not yet fully mated or not yet at full-lock position), while the flag member 10 of the secondary lock system 8 has been elevated pass the upper surface 15 of the secondary lock system 8 and outside of the cavity 75 within the upper portion 80 of the female connector 5 in a visual and tactile warning position for the operator to see and observe.

Further in Stage No. 3 of the engagement steps or assembling process of the connector assembly 1, as illustrated in FIG. 13, the male connector 3 partially inside the female connector 5 engages with the secondary lock system 8, while the flag member 10 of the secondary lock system 8 becomes elevated pass the upper surface 15 of the secondary lock system 8 and outside of the cavity 75 within the upper portion 80 of the female connector 5 in the visual and tactile warning position for the operator to see and observe.

The engagement step or assembling process of Stage No. 3 is more clearly illustrated in the cross-sectional view in FIG. 14, which is taken along cross-sectional line 14-14 in FIG. 13. Here, as the male connector 3 is slide further into or further pushed further towards the female connector 5, an upper surface 88 of the activating member 70 of the male connector 3 finally passes the partially angled bottom portion 40 of the secondary lock system 8, while continuing to be engaged with secondary lock system 8, and finally and specifically engages with the partially flat bottom portion 60 of the secondary lock system 8. While the upper surface 88 of the activating member 70 of the male member 3 transitions, in its engagement with the female connector 5, from the partially angled bottom portion 40 to the partially flat bottom portion 60 of the secondary lock system 8, the secondary lock system 8 simultaneously moves upward inside the cavity 75 located in the upper portion 80 of the female connector 5, which in turn pushes its flag member 10 upwards pass the upper surface 15 of the female connector 5. The flag member 10, now outside of the female connector 5, thus becomes the visual and tactile warning for alerting the operator that the male connector 3 has become partially engaged or is now at a pre-lock position with the female connector 5 (i.e., not yet fully mated or not yet at full-lock position). The visual and tactile warning provided by the flag member 10 for the operator to see and observe, now located outside of the upper surface 15 of the female connector 5, further indicates to the operator that an additional push of the male connector 3 towards the female connector 4 is needed to fully mate the male and female connectors 3, 5 together at a full-lock position in Stage No. 4, as more fully discussed below.

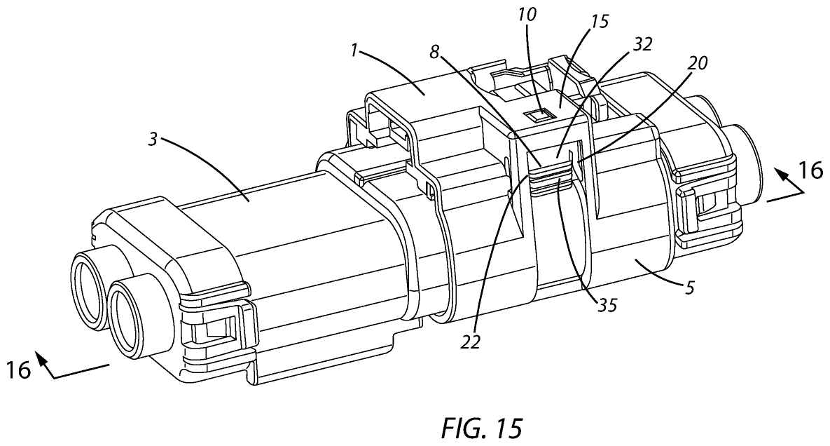

Generally, in the engagement step or assembling process of the connector assembly 1 in Stage No. 4, as shown in the perspective view of the connector assembly 1 in FIG. 15, the male connector 3 enters the female connector 5, such that the male and female connectors 3, 5 become fully-mated or at a full-lock position, while the secondary lock system 8, with the flag member 10 thereon, has returned to its hidden position inside the female connector 5. For reasons more fully discussed below, at Stage No. 4, the ribs or ridges on the right outer side 32 of the secondary lock system 8 are clearly seen through the window 20 passing through the side 22 of the female connector 5.

As illustrated in more detail in FIG. 16, which is a cross-sectional view taken along cross-sectional line 16-16 of FIG. 15, in the engagement step of assembling process of the connector assembly 1 in Stage No. 4, the male connector 3 is further slid into or further pushed towards the female connector 5. Consequently, the upper surface 88 of the activating member 70 of the male connector 3 further traverses the partially flat bottom portion 60 of the secondary lock system 8. When the upper surface 88 of the activating member 70 of the male connector 3 has fully traversed and completely passes the partially flat bottom portion 60 of the secondary lock system 8, the secondary lock system 8 is lowered or falls down onto an upper surface 90 of the male connector 3, the upper surface 90 of the male connector 3 being lower than the upper surface 88 of the activating member 70 of the male connector 3. As discussed above, with respect to FIG. 9, the secondary lock system 8 of this invention includes the tang or lever-like member 38 to provide resiliency for the secondary lock system 8 when operating or traveling, up or down, within the cavity 75 and through the upper surface 15 of the female connector 5; and thus, the secondary lock system 8 of this invention is spring-activated. As the spring-activated secondary lock system 8 is lowered or falls down onto the upper surface 90 of the male connector 3, the flag member 10 of the secondary lock system 8 is similarly lowered below the upper surface 15 of the female connector 5; and thus, the flag member 10 again becomes hidden or conceiled inside the cavity 75 in the upper portion 89 of the female connector 5, which indicates to the operator that male connector and female connectors 3, 5 of the connector assembly 1 are fully-mated or in a full-lock position. More particularly, as further seen in FIG. 16, the secondary lock system 8 of this invention completely blocks or locks the activating member 70 of the male member 3, so that the secondary lock system 8 of this invention blocks, locks, or prevents the male connector 3 from being pulled away out from or being unlocked with the female connector 5.

With the engagement step or assembling process of the connector assembly 1 now in Stage No. 4, after having previously observed or seen the warning signal indicated by the flag member 10 of the secondary lock system 8 protruding outside the upper surface 15 of the female connector 5 in Stage No. 3, the visual and tactile warning provided to the operator by the flag member 10 of the secondary lock system 8 is now absent or removed in Stage No. 4. Consequently, the operator can now be assured that the male and female connectors 3, 5 are fully mated or in a full-lock position, thereby providing the needed assurance to the operator that during the assembling, transport, use, or the like of the connector assembly 1, the male and female connectors 3, 5 are and will remain fully mated or in a full-lock position.

When the male and female connectors 3, 5 of the connector assembly 1 are fully mated or in a full-lock position, as illustrated in FIGS. 15 and 16, it may be necessary for the operator to purposely unlock or disengage the male and female connectors 3, 5. In such a case, the operator may, for example, simply use at least a finger of one hand (or use a tool with one hand) to push at least one of the ribs or ridges 35 (see, e.g., FIG. 15) on the right outer side 32 of the secondary lock system 8 upwards, which in turn pushes the secondary lock system 8 of this invention to move upwards thereby allowing the engagement step or assembling process of the connector assembly 1 to revert from Stage No. 4 to Stage No. 3 (see, e.g., FIGS. 13 and 14), wherein the secondary lock system 8 of this invention unblocks the activating member 70 of the male connector 3, thereby allowing the male connector 3 to be slid away or pulled away from the female connector 5 with the use of, for example, the operator's other hand.

The present invention is not limited to the above-described embodiments; and various modifications in design, structural arrangement or the like may be used without departing from the scope or equivalents of the present invention.

I claim:

1. A secondary lock system for a connector assembly that provides an engaging and warning system to an operator, said connector assembly having a primary lock system, or at least a connector position assurance (CPA) device and a terminal position assurance (TPA) device, said connector assembly having said secondary lock system, comprising:
a male connector having an activating member;
a female connector for accommodating therein said secondary lock system,
wherein said secondary lock system comprises a flag member, said flag member of said secondary lock system movable in or out of said female connector to provide said engaging and warning system to said operator.

2. The secondary lock system for said connector assembly that provides said engaging and warning system to said operator according to claim 1,
wherein said male connector begins to enter said female connector, and
wherein said flag member of said secondary lock system remains hidden inside said female connector.

3. The secondary lock system for said connector assembly that provides said engaging and warning system to said operator according to claim 2,
wherein, when said male connector is slid into or pushed towards said female connector, said male connector begins to engage with said secondary lock system of said female connector, and
wherein said flag member of said secondary lock system remains hidden inside said female connector.

4. The secondary lock system for said connector assembly that provides said engaging and warning system to said operator according to claim 3,
wherein, when said male connector is further slid into or pushed towards said female connector, said male connector engages with said secondary lock system of said female connector, and
wherein said flag member of said secondary lock system is pushed outside of said female connector for providing a visual and tactile warning system for informing said operator that said male and female connectors are partially mated or at a pre-lock position.

5. The secondary lock system for said connector assembly that provides said engaging and warning system to said operator according to claim 4,
wherein, when said male connector is further slid into or pushed towards said female connector, said activating member of said male connector blocks said secondary lock system, which in turn blocks said male connector from being slid out, pulled out, or disengaged away from said female connector, and
wherein said flag member of said secondary lock system returns inside said female connector at a hidden position, which provides a further visual and tactile warning system to said operator that said male and female connectors are fully mated or at a final-lock position.

6. A secondary lock system for a connector assembly that provides an engaging and warning system to an operator, said connector assembly having a primary lock system, or at least a connector position assurance (CPA) device and a terminal position assurance (TPA) device, said connector assembly having said secondary lock system, comprising:
a male connector having an activating member;
a female connector for accommodating therein said secondary lock system,
wherein said secondary lock system comprises a flag member, said flag member of said secondary lock system movable in or out of said female connector to provide said engaging and warning system to said operator, and
wherein said secondary lock system further comprises a partially angled bottom portion and a partially flat bottom portion.

7. The secondary lock system for said connector assembly that provides said engaging and warning system to said operator according to claim 6,
wherein said male connector begins to enter said female connector, and
wherein said flag member of said secondary lock system remains hidden inside said female connector.

8. The secondary lock system for said connector assembly that provides said engaging and warning system to said operator according to claim 7,
wherein, when said male connector is slid into or pushed towards said female connector, said activating member of said male connector begins to engage with said secondary lock system of said female connector, and
wherein said flag member of said secondary lock system remains hidden inside said female connector.

9. The secondary lock system for said connector assembly that provides said engaging and warning system to said operator according to claim 8,
wherein, when said male connector is further slid into or pushed towards said female connector, said activating member of said male connector engages with said partially angled bottom portion and said partially flat bottom portion of said secondary lock system of said female connector, and
wherein, when said activating member of said male connector engages with said partially flat portion of said secondary lock system, said flag member of said secondary lock system is pushed outside of said female connector for providing a visual and tactile warning system for informing said operator that said male and female connectors are partially mated or at a pre-lock position.

10. The secondary lock system for said connector assembly that provides said engaging and warning system to said operator according to claim 9,
wherein, when said male connector is further slid into or pushed towards said female connector, said activating member of said male connector fully traverses said partially flat bottom portion of said secondary lock system and allows said secondary lock system to in turn block said male connector from being slid out, pulled out, or disengaged away from said female connector, and
wherein said flag member of said secondary lock system returns inside said female connector at a bidden position, which provides a further visual and tactile warning system to said operator that said male and female connectors are fully mated or at a final-lock position.

11. The secondary lock system for said connector assembly that provides said engaging and warning system to said operator according to claim 1, wherein said secondary lock system further comprises a tang member or a lever member to provide resilient movement to said secondary lock system when said secondary lock system moves inside said female connector.

12. A method for operating a connector assembly having a secondary lock system that provides an engaging and warning system to an operator, said connector assembly having a primary lock system, and at least a connector position assurance (CPA) device and terminal position assurance (TPA) device, said method comprising the steps of:
having a male connector, which comprises an activating member, begin to enter a female connector in a first stage of engagement steps or an assembling process of said male and female connectors; and
keeping a flag member of said secondary lock system of said female connector, which is movable in or out of said female connector, hidden inside said female connector.

13. The method for operating said connector assembly having said secondary lock system that provides said engaging and warning system to said operator according to claim 12, further comprising the steps of:
sliding or pushing said male connector towards said female connector in a second stage of engagement steps or an assembling process of said male and female connectors, wherein said male connector begins to engage with said secondary lock system of said female connector; and
keeping said flag member of said secondary lock system hidden inside said female connector.

14. The method for operating said connector assembly having said secondary lock system that provides said engaging and warning system to said operator according to claim 13, further comprising the steps of:
further sliding or pushing said male connector towards said female connector in a third stage of engagement steps or an assembling process of said male and female connectors, wherein said male connector engages with said secondary lock system of said female connector; and
pushing said flag member of said secondary lock system outside of said female connector for providing a visual and tactile warning system for informing said operator that said male and female connectors are partially mated or at a pre-lock position.

15. The method for operating said connector assembly having said secondary system that provides said engaging and warning system to said operator according to claim 14, further comprising the steps of:
further sliding or pushing said male connector into said female connector in a fourth stage of engagement steps or an assembling process of said male and female connectors, wherein said activating member of said male connector blocks said secondary lock system, which in turn blocks said male connector from being slid out, pulled out, or disengaged away from said female connector; and
returning said flag member of said secondary lock system inside said female connector at a hidden position, which provides a further visual and tactile warning system to said operator that said male and female connectors are fully mated or at a final-lock position.

16. The secondary lock system for said connector assembly that provides said engaging and warning system to said operator according to claim 1, further comprising a spring element or component for automatically or resiliently moving said flag member of said secondary lock system in or out of said female connector to provide said engaging and warning system to said operator.

17. The secondary lock system for said connector assembly that provides said engaging and warning system to said operator according to claim 4, further comprising a spring element or component for automatically or resiliently moving said flag member of said secondary lock system in or out of said female connector to provide said engaging and warning system to said operator.
